(19) United States
(12) Patent Application Publication
(10) Pub. No.: US 2026/0080434 A1
(43) Pub. Date: Mar. 19, 2026

(54) SYSTEMS AND METHODS FOR BACKEND DIGITAL CONTENT CURATION

(71) Applicant: GOOGLE LLC, Mountain View, CA (US)

(72) Inventors: Haifeng Gong, Fremont, CA (US); Xiaohang Li, Saratoga, CA (US)

(21) Appl. No.: 18/887,905

(22) Filed: Sep. 17, 2024

(51) Int. Cl. G06Q 30/0242; G06F 16/22; G06F 16/25

(52) U.S. Cl. CPC G06Q 30/0246; G06F 16/2237; G06F 16/2264; G06F 16/258

(57) ABSTRACT

A method of curating content includes determining a marginal value of a digital content item to a digital content collection. The method also includes monitoring one or more performance metrics for a digital content item based on user interactions with the digital content item; determining one or more similarity metrics based on a vector embedding of the digital content item and one or more other vector embeddings of one or more other digital content items in the digital content collection; determining the marginal value of the digital content item to the digital content collection based on the one or more performance metrics of the digital content item and at least one similarity metric of the one or more similarity metrics; and based on the marginal value, either removing the digital content item from the digital content collection, or maintaining the digital content item in the digital content collection.

### FIELD OF TECHNOLOGY

The present disclosure relates to collections of digital content, and in particular relates to techniques for increasing and/or maintaining the performance and diversity of a content collection.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

In recent years, significant progress has been made in the field of digital content (e.g., image) generation and modification. In particular, generative artificial intelligence (AI) models have begun to find widespread use in both personal and commercial domains. In the realm of digital advertising, for example, generative AI models provide the ability to generate new assets (i.e., digital advertisements, or digital content used in digital advertisements), including text, images, and videos, that are tailored to enhance user engagement. However, the ability to create and maintain a large collection of such content items (e.g., digital advertisements in a digital advertising account or campaign) poses significant challenges. In particular, conventional methods of content curation result in bloated content collections with numerous poor-performing content items, which can lead to excessive storage requirements and degraded performance (e.g., poor overall performance of a digital advertising account or campaign).

### SUMMARY

In the disclosed techniques, a system improves the quality and diversity of a digital content collection by determining a marginal value of a digital content item to a digital content collection. As the term is used herein, “marginal value” is generally a function of both performance of a digital content item in a content collection, and similarity of the digital content item to other digital content items in the content collection. The marginal value of a particular content item to a content collection can be viewed as the difference between (1) the overall value of the content collection with the particular content item and (2) the overall value of the content collection without the particular content item. For example, a particular digital advertisement may provide a relatively high impression or click-through rate, but be very similar to one or more other digital advertisements in a collection of advertisements. Such an advertisement may not add much value to the collection, despite providing high performance when viewed in isolation.

A system of the present disclosure improves quality and diversity of a content collection by: (1) monitoring performance metrics for a digital content item of digital content collections by monitoring user interactions with the digital content item; (2) determining similarity metrics for the digital content item based on a vector embedding of the digital content item and vector embeddings of other digital content items in the digital content collection; (3) determining a marginal value of the digital content item to the digital content collection based on (i) the performance metrics of the digital content item and (ii) at least one similarity metric; and (4) based on the marginal value, either removing the digital content item from the digital content collection or maintaining the digital content item in the digital content collection.

As noted above, by assessing the marginal value of each digital content item to a digital content collection, the system provides improvements to the performance and diversity of digital content collections. That is, the system maintains high performance and overall value of a digital content collection in a manner that avoids excessive duplication, thereby eliminating the need for excessive storage capacity, and computational resources as occurs in conventionally maintained digital content collections. Such an approach can ensure that a digital content collection remains relevant and effective in achieving desired performance outcomes. Moreover, the system can avoid the clutter that makes digital content collections difficult to track or manage.

Another advantage stems from the fact that the disclosed techniques can be automatically performed as backend processing on a continuous basis (e.g., a periodic basis, a stochastic basis, a deterministic basis, etc.) in order to continuously improve and/or maintain the performance of a content collection. A continuously evolving and improving content collection can be produced, with no manual input or with minimal manual input (e.g., manual confirmation before a digital content item is put into circulation for a digital advertising campaign), by employing generative artificial intelligence techniques.

In summary, the disclosed system provides improvements to digital content management systems by maintaining or improving performance of the content while reducing computational load and storage requirements and generally reducing complexity (e.g., complexity of a digital advertisement account).

Other advantages will also become apparent to one of ordinary skill in the art upon reading this disclosure and viewing the corresponding drawings.

In one aspect, a method of curating content includes monitoring, by one or more processors, one or more performance metrics for a digital content item of a digital content collection based on user interactions with the digital content item. The method also includes determining, by the one or more processors, one or more similarity metrics based on a vector embedding of the digital content item and one or more other vector embeddings of one or more other digital content items in the digital content collection; determining, by the one or more processors, a marginal value of the digital content item to the digital content collection based on (i) the one or more performance metrics of the digital content item and (ii) at least one similarity metric of the one or more similarity metrics; and based on the marginal value, either removing, by the one or more processors, the digital content item from the digital content collection, or maintaining, by the one or more processors, the digital content item in the digital content collection.

In another aspect, a system includes one or more processors and one or more memories storing instructions that, when executed by the one or more processors, cause the one or more processors to: (1) monitor one or more performance metrics for a digital content item of a digital content collection based on user interactions with the digital content item; (2) determine one or more similarity metrics based on a vector embedding of the digital content item and one or more other vector embeddings of one or more other digital content items in the digital content collection; (3) determine a marginal value of the digital content item to the digital content collection based on (i) the one or more performance metrics of the digital content item and (ii) at least one similarity metric of the one or more similarity metrics; and (4) based on the marginal value, either remove the digital content item from the digital content collection, or maintain the digital content item in the digital content collection.

In another aspect, one or more non-transitory, computer-readable media store instructions that, when executed by one or more processors, cause the one or more processors to: (1) monitor one or more performance metrics for a digital content item of a digital content collection based on user interactions with the digital content item; (2) determine one or more similarity metrics based on a vector embedding of the digital content item and one or more other vector embeddings of one or more other digital content items in the digital content collection; (3) determine a marginal value of the digital content item to the digital content collection based on (i) the one or more performance metrics of the digital content item and (ii) at least one similarity metric of the one or more similarity metrics; and (4) based on the marginal value, either remove the digital content item from the digital content collection, or maintain the digital content item in the digital content collection.

### BRIEF DESCRIPTION OF THE DRAWINGS

FIG. 1 is a block diagram of an example system in which techniques curating content can be implemented.

FIG. 2 is a time-series diagram of a content curation process for a content item.

FIG. 3 is a block diagram of a content collection management process for improving quality and diversity of a content collection.

FIG. 4 is a flow diagram of an example method for curating content.

### DETAILED DESCRIPTION OF THE DRAWINGS

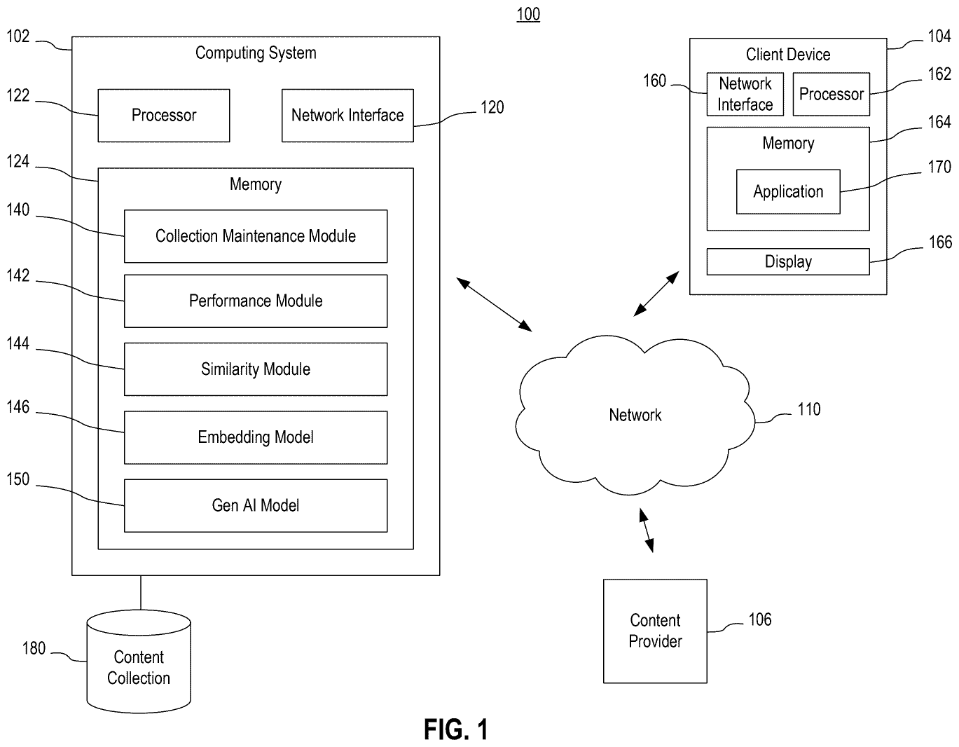

FIG. 1 is a block diagram of an example system 100 in which techniques for curating content can be implemented. The example system 100 includes a computing system 102, a client device 104, a content provider 106, a network 110, and a content collection 180. The computing system 102 is remote from the client device 104 and content provider 106, and is communicatively coupled to the client device 104 and content provider 106 via the network 110. In some implementations, the system 100 does not include client device 104 and/or content provider 106.

The network 110 may be a single communication network (e.g., the Internet), and in some implementations also includes one or more additional networks. As just one example, the network 110 may include a cellular network, the Internet, and a server-side local area network (LAN). While FIG. 1 shows only a single client device 104 and a single content provider 106, it is understood that the computing system 102 may also be in communication with a number (e.g., millions) of other client devices that are generally similar to the client device 104, and/or in communication with a number (e.g., thousands) of other content providers that are generally similar to content provider 106.

Generally, computing system 102 can improve digital content collections (e.g., for providers such as content provider 106) by removing a digital content item from, or maintaining a digital content item within, a digital content collection based on a marginal value of the digital content item to the collection. As noted above, the term “marginal value” is generally used herein to refer to a function of both performance of a digital content item in a content collection, and similarity of the digital content item to other digital content items in the content collection. Moreover, the computing system 102 either removes or maintains a digital content item in a content collection based on performance of the digital content item and the similarity of the digital content item to other digital content items in the content collection.

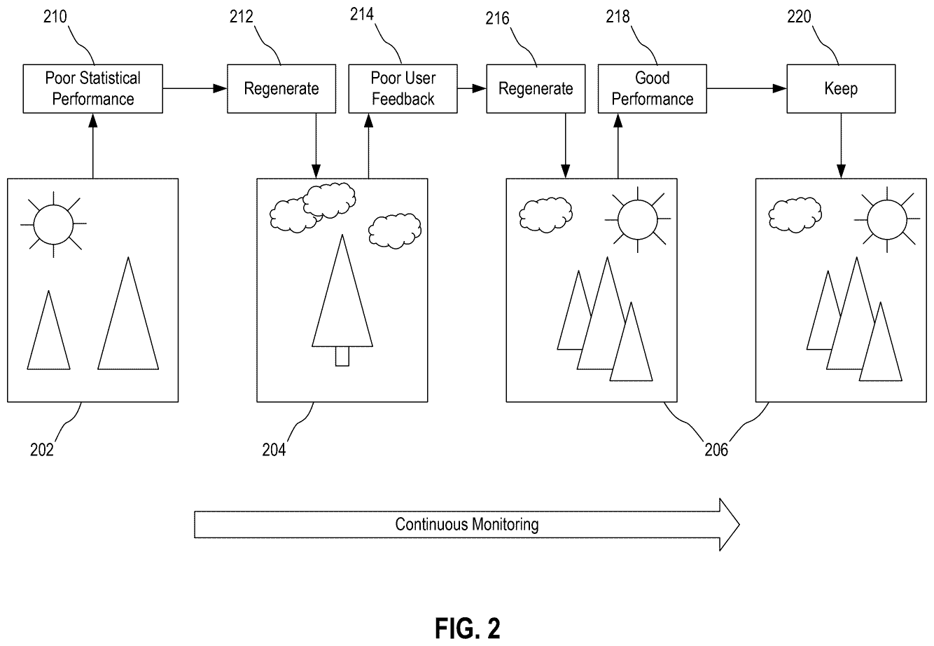

The computing system 102 may assess a digital content collection (e.g., content collection 180) of a content provider such as content provider 106 based on the marginal value of each digital content item to the digital content collection. In one such example, a digital content item (e.g., one or more digital images), with moderate to high measurable performance (e.g., based on click-through rate, conversion rate, etc.), may be substantially dissimilar to other digital content items in a content collection and thereby significantly improve the overall quality of the collection. As a counter example, a digital content item with low, moderate, or high measurable performance may be substantially similar to one or more other digital content items in the content collection and thus fail to significantly improve the overall quality of the collection. Notably, the techniques described herein (e.g., in connection with FIGS. 2, 3, and 4) can update and manage a digital content collection in a more effectively and efficient manner than conventional techniques (e.g., simply maintaining all content items, with or without high performance, to a collection) by determining a marginal value of a digital content item to the content collection and pruning (removing, deleting, discarding, etc.) content items that do not substantially improve the overall performance of the content collection. While other contexts are also possible, for ease and consistency of explanation this disclosure primarily uses examples that are related to a digital advertising implementation/context.

The client device 104 is generally configured to access information resources (e.g., web pages and/or user interfaces of mobile applications or other applications) that can present the digital content from the content collection 180. For example, computing system 102 may generate digital advertisements that include (or consist entirely of) the digital content items discussed herein (e.g., the digital content items of the content collection 180, and/or a new digital content item added to the content collection 180). Computing system 102 or another computing system may then serve the digital advertisements to users of client device 104 and/or other similar client devices using suitable techniques, such as conducting auctions (e.g., auctions based on keyword bids by advertisers, relevancy metrics, etc.). The digital advertisements may be served in slots of web pages visited by the users, and/or slots of application user interfaces displayed to the users, etc.

The content provider 106 generally may commission or request that computing system 102 expand, update, and/or refine the content collection 180 to improve the quality/performance and diversity of the content collection 180. For example, content provider 106 may be a digital advertiser that provides one or more digital advertisement images for each of a number of offered products or services, as part of one or more advertising campaigns owned or managed by content provider 106. As other examples, the computing system 102 (or another computing system) may generate some or all of the digital content items of content collection 180 based on other content items provided by content provider 106.

The computing system 102 includes a network interface 120, a processor 122, and memory 124. The network interface 120 includes hardware, firmware, and/or software configured to enable the computing system 102 to exchange electronic data with the client device 104 and other, similar client devices (and possibly content provider 106, etc.) via the network 110. For example, the network interface 120 may include a wired or wireless router and a modem. The processor 122 may be a single processor (e.g., a central processing unit (CPU)), or may include multiple processors (e.g., multiple CPUs, or one or more CPUs and one or more graphics processing units (GPUs)). Computing system 102 may be a single computing device (e.g., server) at a single location, or may include multiple, coordinating computing devices that are either co-located or remotely distributed.

The memory 124 is a computer-readable, non-transitory storage unit or device, or collection of such units/devices, that may include persistent and/or non-persistent memory components. The memory 124 stores instructions executable by processor 122 to perform various operations, including the instructions of various software applications and the data generated and/or used by such applications. In the example system 100 of FIG. 1, memory 124 stores the instructions of a collection maintenance module 140, a performance module 142, a similarity module 144, and an embedding model 146, each of which can be executed by processor 122.

Memory 124 can also store one or more generative artificial intelligence (AI) models, in some implementations. In particular, in the example system 100 of FIG. 1, memory 124 stores a generative AI model 150 used to generate new digital content items. For example, the generative AI model 150 may generate a digital content item based on one or more text prompts and one or more visual embeddings. In other implementations, the generative AI model 150 is not included in system 100. More generally, it is understood that, in some implementations, memory 124 may omit one or more modules/elements shown in FIG. 1, such as the similarity module 144 and/or the collection maintenance module 140. It is also understood that, in some implementations, memory 124 may include one or more additional modules/elements not shown in FIG. 1, such as modules that facilitate serving images (e.g., digital advertisements) to users of devices such as client device 104. In some implementations, generative AI model 150 is not stored in memory 124, and instead is stored in one or more remote servers or other computing systems. For example, the generative AI model 150 may be remotely accessed (e.g., as a cloud service) by the collection maintenance module 140 to obtain new digital content items for the content collection 180.

The client device 104 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1, client device 104 includes a network interface 160, a processor 162, memory 164, and a display 166. The processor 162 may be a single processor, or may include multiple processors.

The memory 164 includes one or more computer-readable, non-transitory storage units or devices, which may include persistent and/or non-persistent memory components. The memory 164 stores instructions that are executable by processor 162 to perform various operations, including the instructions of various software applications and the data generated and/or used by such applications.

In the example system 100 of FIG. 1, memory 164 stores at least an application 170. Generally, application 170 is executed by processor 162 to provide one or more user interfaces via display 166, where the user interface(s) enable a user to access information resources that can include digital content items generated by computing system 102. For example, application 170 may be a web browser application, and digital content items generated by computing system 102 may be included in content slots of web pages visited by the user and presented on display 166. As a more specific example, the digital content items may be digital advertisements that are generated by computing system 102, and then selected and provided to client device 104 by computing system 102 (or by another computing system) for insertion in the content slots. In other implementations, application 170 is a dedicated application (e.g., a “mobile app”), and digital content items generated by computing system 102 are included in content slots of user interfaces that are presented by the application 170 on display 166.

The display 166 includes hardware, firmware, and/or software configured to enable a user to view visual outputs of the client device 104, and may use any suitable display technology (e.g., LED, OLED, LCD, etc.). In some implementations, the display 166 is incorporated in a touchscreen having both display and manual input capabilities. Moreover, in some implementations where the client device 104 is a wearable device, the display 166 is a transparent viewing component (e.g., lenses of smart glasses) with integrated electronic components. For example, the display 166 may include micro-LED or OLED electronics embedded in lenses of smart glasses.

The network interface 160 includes hardware, firmware, and/or software configured to enable the client device 104 to exchange electronic data with the computing system 102 via the network 110. For example, the network interface 160 may include a cellular communication transceiver, a WiFi transceiver, and/or transceivers for one or more other wired and/or wireless communication technologies.

While FIG. 1 shows client device 104 as a single component communicating directly (i.e., via network 110) with the computing system 102, in some implementations the subcomponents of client device 104 are instead divided among two or more user-side devices. As just one example, a pair of smart glasses may include the processor 162, the memory 164, and the display 166, while a smartphone may include another processing unit, another memory, another display, and the network interface 160. The smart glasses may then communicate as needed with the smartphone (e.g., via Bluetooth) to enable the operations described herein.

Returning to the computing system 102, the collection maintenance module 140 generally operates by determining the marginal value of digital content items (e.g., from a digital advertising campaign) to a digital content collection such as content collection 180 and by keeping and/or rejecting particular digital content items based on their marginal value to content collection 180. The collection maintenance module 140 may, based on the marginal value of a digital content item, either: remove the digital content item from content collection 180, or maintain the digital content item in content collection 180. In some implementations, a marginal value for each content item in the content collection 180 is determined. Additionally or alternatively, in some implementations, computing system 102 determines the marginal value for one or more digital content items newly added to content collection 180 (e.g., digital content item(s) generated using the generative AI model 150). For example, a predictive AI model (e.g., neural network) of computing system 102 may predict performance of a newly added digital content item, and computing system 102 may then use that predicted performance to calculate the marginal value of the new content item as discussed herein (and prune or keep the new content item based on that marginal value).

The performance module 142 monitors performance for the digital content item based on user interaction with the digital content item, and moreover, monitors performance metrics for digital content items. The performance metrics may be, for example: (1) one or more statistical performance metrics (e.g., average click-through-rate, conversion rate, impressions, etc.), (2) user feedback data (e.g., from the content provider 106), or some combination thereof. In some implementations, the statistical performance metrics are obtained, by the performance module 142, from a separate entity (e.g., a separate data analytics server, the content provider, a digital marketing analyst, an analytics tool, etc.), and/or the statistical performance metrics may be sent, by the separate entity, to the performance module 142. For example, the performance module 142 may include instructions for obtaining feedback data for a digital content item from a content provider such as content provider 106 and for generating a performance metric based on the feedback data. As another example, the performance module 142 may include instructions for obtaining statistical performance metrics for a digital content item (e.g., from a separate entity), and generating performance metrics based on the statistical performance metrics.

The similarity module 144 determines, or generates, similarity metrics for the digital content item based on the similarity between the digital content item and other digital content items in content collection 180. Each similarity metric may be determined by the similarity module 144 based on a vector embedding/representation of the digital content item and vector embeddings of some or all of the other digital content items in the content collection 180. To this end, the embedding model 146 may convert digital content items to a vector in a multidimensional vector space, which may be stored on/with the content collection 180 or another digital database/datastore. For example, the embedding model 146 may be a neural network or one or more embedding layers of a neural network.

The similarity module 144 may determine, or generate, the similarity metrics by computing a proximity, in the multidimensional vector space, of a vector embedding of a digital content item to the other vector embeddings of digital content items in the content collection 180. In some implementations, determining the similarity metrics includes calculating cosine similarity between (1) the vector embeddings of a digital content item and (2) each of the vector embeddings of the other digital content items in the content collection 180.

The collection maintenance module 140 may determine the marginal value of a digital content item to a digital content collection (e.g., a measure of the overall value of a digital content item to a digital content collection), such as the content collection 180, based on performance metrics for the digital content (as determined by the performance module 142) and at least one similarity metric of the similarity metrics determined/generated by the similarity module 144. For example, the performance metrics for a digital content item may be individual performance metrics for the content item (e.g., statistical performance metrics for an individual content item), aggregated performance metrics for the digital content item (e.g., statistical performance metrics for a content item normalized to the performance metrics for other items in a content collection), and so on. In some example implementations, collection maintenance module 140 calculates the marginal value of a particular content item based on (1) the performance of the particular content item and (2) a similarity metric for the single other content item in content collection 180 that is most similar to the particular content item (e.g., the highest similarity metric). For example, determining the marginal value may include discounting a performance metric of a content item using a discount factor that is based on a similarity metric of the content item. In other example implementations, collection maintenance module 140 calculates the marginal value of a particular content item based on (1) the performance of the particular content item and (2) a set of N similarity metrics for the N other content items in content collection 180 that are most similar to the particular content item (e.g., a similarity score that collection maintenance module 140 calculates based on the highest N similarity metrics), where N is any suitable integer greater than zero. By determining the marginal value of a digital content item, based on both the performance of the digital content item and its similarity to other content, the system enhances the performance/quality and diversity of the digital content collections as discussed.

The content collection 180 may be a digital content collection database/datastore, and may store a plurality of digital content items (e.g., with each digital content item discussed herein being an image, a video, a frames of a video, etc.) of a content provider such as content provider 106. For example, the content items in the content collection 180 may correspond to an advertising campaign owned or managed by content provider 106.

FIG. 2 is a time-series diagram of a content curation process 200 for a content item. The content curation process 200 may be implemented by any suitable computing system, such as the computing system 102 (e.g., by the collection maintenance module 140) of FIG. 1, for example. For ease of explanation, content curation process 200 is described with reference to an implementation in which the process 200 is performed by the computing system 102 (e.g., by the collection maintenance module 140 of FIG. 1).

The example content curation process 200 includes monitoring a first content item 202, a first modified content item 204, and a second modified content item 206. In the content curation process 200, the collection maintenance module 140 obtains/analyzes statistical performance (e.g., average click-through-rate, conversion rate, or impressions), user feedback (e.g., feedback from a content provider), and overall performance (e.g., a combination of statistical performance and user feedback). In the example scenario of FIG. 2, poor statistical performance (e.g., a low click-through rate, etc.) is associated with the first content item 202 (block 210). In response to obtaining/receiving an indication of this poor statistical performance, the collection maintenance module 140 generates (or otherwise obtains) a first modified content item 204 (block 212) (e.g., a modified version of the first content item 202), thereby removing the first content item 202 itself from the content collection. Later in the scenario of FIG. 2, the collection maintenance module 140 receives poor user feedback associated with the first modified content item 204 (block 214). In response to receiving/obtaining poor user feedback for the first modified content item 204, collection maintenance module 140 generates a second modified content item 206 (block 216) (e.g., a modified version of the first modified content item 204 and/or the first content item 202), thereby removing the first modified content item 204 from the content collection. In the example of FIG. 2, the collection maintenance module 140 receives an indication of good performance (e.g., good statistical performance and/or positive user feedback) associated with the second modified content item 206 (block 218). In response to receiving/obtaining an indication of good performance for the second modified content item 206, the collection maintenance module 140 keeps the modified content item 206 (block 220) in the content collection (e.g., the content collection 180 of FIG. 1).

It should be understood that, despite FIG. 2 depicting three content items (e.g., the first content item 202, the first modified content item 204, and the second modified content item 206), any number of content items, or variations of a content item, may be monitored (e.g., monitored on a periodic basis, a stochastic basis, a deterministic basis, etc., or monitored once after a predetermined time period, etc.) via the content curation process 200. Additionally, it should be understood that statistical performance and user feedback may be monitored simultaneously, in the content curation process 200, and that FIG. 2 depicts an example in which digital content item 202 and digital content item 204 are respectively associated with poor statistical performance and poor user feedback for ease of explanation. For example, digital content item 202 and digital content item 204 could be associated with either of, or both of, poor user feedback and poor statistical performance. In some implementations, the process 200 does not obtain or evaluate user feedback.

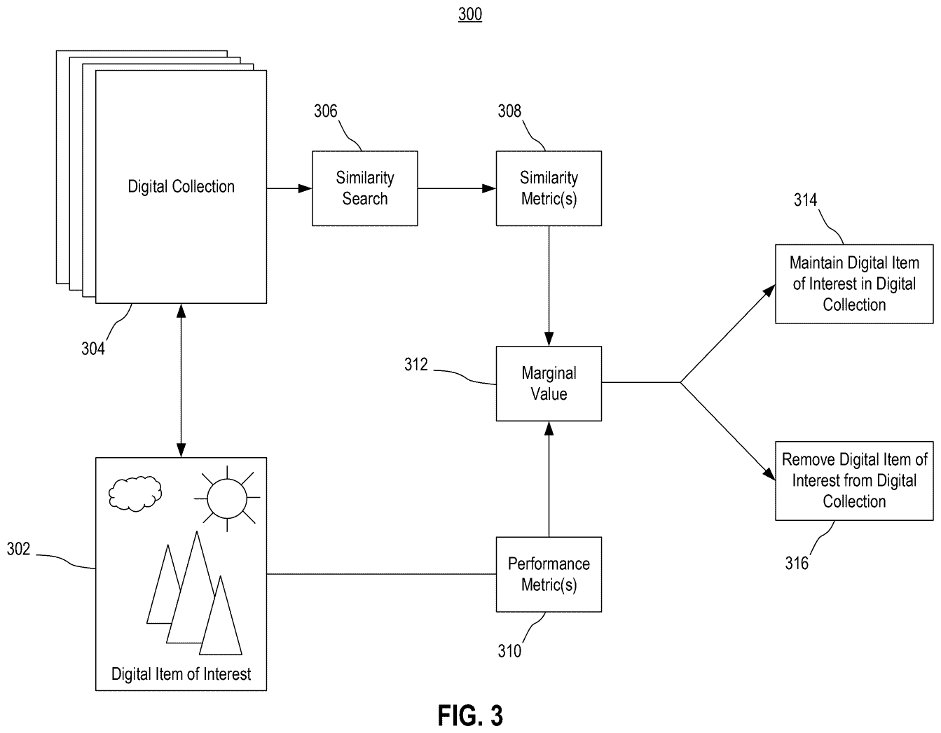

FIG. 3 is a block diagram of a content collection management process 300 for content curation. The collection management process 300 may be implemented by the computing system 102 (e.g., via the similarity module 144, and/or the collection maintenance module 140) of FIG. 1, for example. FIG. 3 depicts an example of determining a marginal value of a digital content item to a content collection (e.g., content collection 180 of FIG. 1) for the purposes of determining whether to remove (e.g., block 212 or block 216 of FIG. 2) or maintain (e.g., block 220 of FIG. 2) the digital content item in the content collection.

The content collection management process 300 includes assessing a marginal value of a digital content item of interest 302 to a digital content collection 304 (e.g., the content collection 180 of FIG. 1), and performing a similarity search/computation (block 306) of the digital content collection 304, to determine one or more similarity metrics 308. For example, each content item in the digital content collection 304 may be associated with a corresponding vector embedding (e.g., the digital content collection 304 may be, or may be associated with, a vector database), and a vector embedding of the digital item of interest 302 may be compared to vector embeddings of other digital content items in the digital content collection 304 (e.g., to vector embeddings of all the other digital content items in the collection) to generate similarity metrics 308 (e.g., computed similarity of the most similar vector embedding; a measure of the proximity of vector embeddings in a vector space, such as cosine similarity).

The digital content item of interest 302 may be associated with one or more performance metrics 310. For example, the performance metrics 310 may be statistical performance metrics (e.g., average click-through-rate, conversion rate, or impressions) and/or user feedback performance metrics (e.g., feedback from a content provider).

Based on the similarity metrics 308 and the performance metrics 310, a marginal value 312, or overall value, of the digital item of interest 302 to the digital content collection 304 may be determined/calculated. Moreover, the marginal value 312 corresponds to both the similarity of the digital content item of interest 302 to one or more digital content items (e.g., the most similar other digital content item in the content collection) in the digital content collection 304 (e.g., similarity metrics 308) and the performance of the digital content item of interest 302 (e.g., performance metrics 310). In some implementations, determining the marginal value includes discounting the performance metric 310 using a discount factor that is based on the similarity metric 308. For example, if performance metric 310 is X and similarity metric 308 is Y, where Y is a normalized value (e.g., Y=0 for no similarity between content items, and Y=1 for identical content items), the marginal value (MV) could be computed as: MV=X·(1−Y); MV=αX·β(1−Y); MV=X^{(1-Y)}; etc., where α and β are weights (e.g., numbers having suitable values between 0 and 1).

In some implementations, a marginal value is determined for all digital content items in the digital content collection 304. In some implementations, a marginal value is determined for new digital content items added to the digital content collection 304 (e.g., using an AI prediction as discussed above). In either case, based on the marginal value 312, the digital content item of interest 302 may be maintained in the digital content collection 304 (block 314), or removed from the digital content collection 304 (block 316). For example, the digital content item of interest 302 may be removed or maintained based on the marginal value 312 falling below or exceeding, respectively, a threshold marginal value. In some implementations, the marginal value of the digital content item 302 is assessed in response to the performance metrics 310 exceeding a predetermined value.

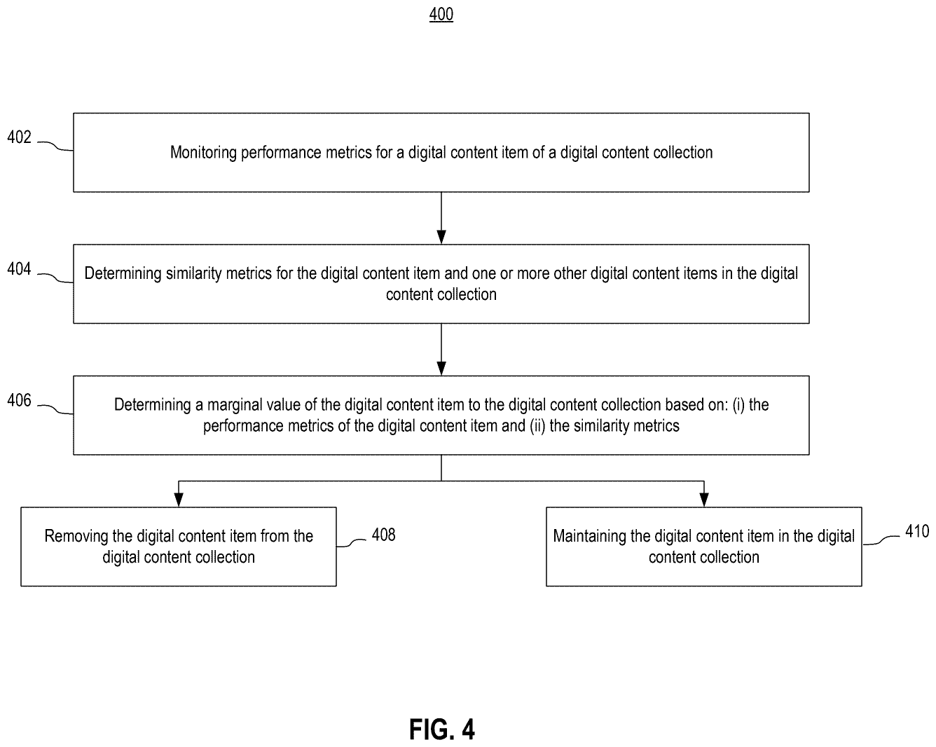

FIG. 4 is a flow diagram of an example method 400 for curating content. The method 400 may be implemented by the computing system 102 (e.g., via the collection maintenance module 140, possibly with the performance module 142 and/or the similarity module 144, etc.) of FIG. 1, for example.

At block 402, performance for a digital content item is monitored. Block 402 includes monitoring one or more performance metrics (e.g., by, or based on data received from, performance module 142 of FIG. 1) for a digital content item of a digital content collection (e.g., content collection 180 of FIG. 1) based on user interactions with the digital content item. In some implementations, block 402 includes obtaining feedback data for the digital content item from a content provider (e.g., content provider 106 of FIG. 1) associated with the digital content collection, and generating at least one of the one or more performance metrics based on the feedback data. For example, the content provider may indicate that they like or dislike the digital content item. In some implementations, block 402 includes obtaining one or more statistical performance metrics for the digital content item, and generating at least one of the one or more performance metrics based on at least one of the one or more statistical performance metrics. For example, the one or more statistical performance metrics may be indicative of one or more of: a number or rate of click-through events, a number or rate of conversion events, or a number or rate of impression events.

At block 404, similarity metrics for the digital content item and other digital content items in the digital content collection are determined. Block 404 includes determining one or more similarity metrics (e.g., via similarity module 144 of FIG. 1) based on a vector embedding of the digital content item and one or more other vector embeddings of one or more other digital content items in the digital content collection. In some implementations, block 404 includes generating, using an embedding layer (e.g., the embedding model 146 of FIG. 1) that converts digital content items to a multidimensional vector space, the vector embedding and the one or more other vector embeddings. In some implementations, block 404 includes computing a proximity, in the multidimensional vector space, of the vector embedding to each of the one or more other vector embeddings to determine the one or more similarity metrics. For example, computing the proximity may include calculating cosine similarity between the vector embedding of the digital content item and each of the one or more other vector embeddings.

At block 406, a marginal value of the digital content item to the digital content collection is determined. Block 406 includes determining a marginal value (e.g., via collection maintenance module 140 of FIG. 1) of the digital content item to the digital content collection based on (a) the one or more performance metrics of the digital content item and (ii) at least one similarity metric of the one or more similarity metrics. For example, block 406 may include determining the marginal value of the digital content item to the digital content collection based on the highest similarity metric between the digital content item and the other digital content items in the collection (e.g., based on the cosine similarity between the digital content item and the closest, or most similar, other digital content item), or based on the highest N similarity metrics, etc. In some implementations, the one or more performance metrics include a first performance metric, the one or more similarity metrics include a first similarity metric, and determining the marginal value includes discounting the first performance metric using a discount factor that is based on the first similarity metric.

At block 408 and block 410, either the digital content item is removed from the digital content collection or the digital content item is maintained in the digital content collection. Block 408 includes removing the digital content item from the digital content collection based on the marginal value. Block 408 may include deleting the digital content item, removing a pointer to (or entry for, etc.) the digital content item in a database, flagging the digital content item such that the digital content item can be overwritten, and so on. Block 410 includes maintaining the digital content item in the digital content collection (e.g., refraining from removing the digital content item from the collection) based on the marginal value.

The method 400 may include one or more additional blocks not shown in FIG. 4. For example, the method 400 may include iterations for multiple digital content items (e.g., determining marginal values for all digital content items in the content collection, or a portion of digital content items in the content collection such as the portion of digital content items that fall below a performance threshold). As another example, the method 400 may include generating a plurality of new digital content items using a generative artificial intelligence model (e.g., generative AI model 150), and adding these new digital content items to the digital content collection.

It is understood that the blocks of FIG. 4 need not be performed strictly in the order shown. For example, block 404 may in parallel with block 402.

As is apparent from the above description, techniques disclosed herein use artificial intelligence to generate high-performing images. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and finetuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

In some implementations, the computing system 102 uses one or more of the machine learning models or techniques noted above to perform any one or more of the operations discussed herein in connection with machine learning. For example, the computing system 102 may use one or more such machine learning techniques to pre-train and/or finetune the generative AI model 150, and possibly to pre-train and/or finetune a model that predicts performance of an image (e.g., for newly added content items as discussed above), etc.

Although the foregoing text sets forth a detailed description of numerous different aspects and implementations of the invention, it should be understood that the scope of the patent is defined by the words of the claims set forth at the end of this patent. The detailed description is to be construed as exemplary only and does not describe every possible implementation because describing every possible implementation would be impractical, if not impossible. Numerous alternative implementations could be implemented, using either current technology or technology developed after the filing date of this patent, which would still fall within the scope of the claims.

The following additional considerations apply to the foregoing discussion and the appended claims. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first set of one or more processors (e.g., in a first computing device) generates X and a distinct, second set of one or more processors (e.g., in a different, second computing device) independently generates Y; (2) implementations in which all processors in the set of one or more processors (e.g., all in the same device, or distributed among multiple devices) contribute to the generation of both X and Y; and (3) other variations.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

1. A method for curating content, the method comprising:
generating, by one or more processors using a generative artificial intelligence (AI) model, a candidate digital content item for potential inclusion in a digital content collection;
predicting, by the one or more processors using a predictive AI model, one or more performance metrics for the candidate digital content item, wherein the one or more performance metrics are indicative of expected user interactions with the candidate digital content item;
determining, by the one or more processors, one or more similarity metrics based on a vector embedding of the candidate digital content item and one or more other vector embeddings of one or more digital content items in the digital content collection;
determining, by the one or more processors, a marginal value of the candidate digital content item to the digital content collection based on (i) the one or more performance metrics of the candidate digital content item and (ii) at least one similarity metric of the one or more similarity metrics; and
based on the marginal value, adding, by the one or more processors, the candidate digital content item to the digital content collection.

2. (canceled)

3. The method of claim 1, further comprising:
generating, by the one or more processors and using an embedding layer that converts digital content items to a multidimensional vector space, the vector embedding and the one or more other vector embeddings.

4. The method of claim 3, wherein determining the one or more similarity metrics includes computing a proximity, in the multidimensional vector space, of the vector embedding to each of the one or more other vector embeddings.

5. The method of claim 4, wherein computing the proximity includes calculating cosine similarity between the vector embedding of the candidate digital content item and each of the one or more other vector embeddings.

6. (canceled)

7. The method of claim 1,
wherein at least one of the one or more performance metrics is based on one or more statistical performance metrics.

8. The method of claim 7, wherein the one or more statistical performance metrics are indicative of one or more of a number or rate of click-through events, a number or rate of conversion events, or a number or rate of impression events.

9. The method of claim 1,
wherein generating the candidate digital content item using the generative AI model is based on a text prompt and a visual embedding.

10. The method of claim 1, wherein the candidate digital content item includes at least one digital image.

11. The method of claim 1, wherein the one or more performance metrics include a first performance metric, wherein the one or more similarity metrics include a first similarity metric, and wherein determining the marginal value includes discounting the first performance metric using a discount factor that is based on the first similarity metric.

12. A computing system for curating content, the computing system comprising:
one or more processors; and
one or more non-transitory memories having stored thereon computer-executable instructions that, when executed by the one or more processors, cause the computing system to:
generate, using a generative artificial intelligence (AI) model, a candidate digital content item for potential inclusion in a digital content collection;
predict, using a predictive AI model, one or more performance metrics for the candidate digital content item, wherein the one or more performance metrics are indicative of expected user interactions with the candidate digital content item;
determine one or more similarity metrics based on a vector embedding of the candidate digital content item and one or more other vector embeddings of one or more other digital content items in the digital content collection;
determine a marginal value of the candidate digital content item to the digital content collection based on (i) the one or more performance metrics of the candidate digital content item and (ii) at least one similarity metric of the one or more similarity metrics; and
based on the marginal value, add the candidate digital content item to the digital content collection.

13. (canceled)

14. The computing system of claim 12, the one or more non-transitory memories having stored thereon computer executable instructions that, when executed by the one or more processors, cause the computing system to:
generate, using an embedding layer that converts digital content items to a multidimensional vector space, the vector embedding and the one or more other vector embeddings.

15. The computing system of claim 14, wherein determining the one or more similarity metrics includes computing a proximity, in the multidimensional vector space, of the vector embedding to each of the one or more other vector embeddings.

16. The computing system of claim 15, wherein computing the proximity includes calculating cosine similarity between the vector embedding of the candidate digital content item and each of the one or more other vector embeddings.

17. (canceled)

18. The computing system of claim 12, wherein at least one of the one or more performance metrics is based on one or more statistical performance metrics.

19. The computing system of claim 18, wherein the one or more statistical performance metrics are indicative of one or more of a number or rate of click-through events, a number or rate of conversion events, or a number or rate of impression events.

20. The computing system of claim 12, wherein the one or more performance metrics include a first performance metric, wherein the one or more similarity metrics include a first similarity metric, and wherein determining the marginal value includes discounting the first performance metric using a discount factor that is based on the first similarity metric.
